(19) United States
(12) Patent Application Publication
(10) Pub. No.: US 2011/0125354 A1
(43) Pub. Date: May 26, 2011

(54) METHOD FOR REGULATING A DRAG TORQUE OF A MOTOR VEHICLE DRIVEN BY AN ELECTRIC MOTOR IN CONSIDERATION OF THE COEFFICIENT OF FRICTION PRESENT ON THE ROADWAY SURFACE, AND DEVICE FOR CARRYING OUT SUCH A METHOD

(76) Inventors: Ulrich Gottwick, Stuttgart (DE); Juergen Binder, Filderstadt-Plattenhardt (DE)

(21) Appl. No.: 12/736,853

(22) PCT Filed: Apr. 3, 2009
(86) PCT No.: PCT/EP2009/053991

§ 371 Date: Jan. 31, 2011

(30) Foreign Application Priority Data
May 26, 2008 (DE) 10 2008 001 973.9

(51) Int. Cl. B60L 15/20

(52) U.S. Cl. 701/22

(57) ABSTRACT

A method for regulating a drag torque of a motor vehicle driven by an electric motor, a regulating device influencing the drag torque in response to a corresponding change in the setting of the accelerator, a sensor device sensing a tire on a roadway surface on which the motor vehicle is located, and providing this to a computing device, whereupon the computing device causes the regulating device to adjust the drag torque as a function of the coefficient of friction. The present invention also relates to a device having means suitable for carrying out such a method.

### BACKGROUND OF THE INVENTION

1. Field of the Invention

The present invention relates to a method for regulating a drag torque of a motor vehicle driven by an electric motor, a regulating device influencing the drag torque in response to a corresponding change in the setting of the accelerator.

2. Description of Related Art

The type of vehicle used most frequently at this time uses internal combustion engines. During the course of the last few decades, the average driver of such motor vehicles has become used to the decelerating behavior of the vehicle when he “takes his foot off the gas”. Based on changed environmental conditions, the use of electric motor vehicles is becoming ever more frequent.

Both motor vehicles that are driven by electric motors and by internal combustion engines have an accelerator that the driver acts upon using his foot, in order to determine the speed.

However, vehicles having an electric drive motor do not produce any motor drag torque worth mentioning. Now, in order to simulate the accustomed engine drag torque behavior also in the case of motor vehicles driven by an electric motor, people have taken up regulating the drag torque appropriately.

To do this, besides making a conventional braking intervention, the possibility also exists of intervening via the electric motor itself, that is also designated as an e-machine.

Systems known in this regard call up regenerative and/or recuperative braking, while using the generator properties of an externally driven electric drive motor, so that electrical energy may be supplied to an accumulator, for example.

Such a system is known from published German patent application document DE 10 2004 023 619 A1. Alternatively to using the electric motor in a generator operation, it is also possible to switch in additional electrical users, or to switch in an ohmic resistor.

In existing regulations for adjusting drag torque, there is the disadvantage that, in the case of a slippery roadway surface, perhaps caused by glare ice or snow during the occurrence of an artificial drag torque, the wheels of the motor vehicle begin to slip. That sort of slipping is undesirable, however, because it goes counter to the exact control of the motor vehicle.

### SUMMARY OF THE INVENTION

In view of the sketched related art, the present invention is based on the object of avoiding the disadvantages encountered in the related art.

This object is attained generically by having a sensor device sensing a coefficient of friction of a roadway surface, on which the motor vehicle is located, and making it available to a computing device, whereupon the computing device causes the regulating device to adjust the drag torque as a function of the coefficient of friction.

Because of this preventive measure, the driving behavior becomes substantially more stable, because no braking slip is sensed any more or subsequently has to be compensated for. The countermeasures that would otherwise be needed may be omitted. Because of the adaptive adjustment of the drag torque conditions to the roadway conditions, the blocking inclination at the wheels, especially at the drive wheels of the motor vehicle, is reduced, which leads to a safe driving dynamics response of the motor vehicle. One may do without the usual active opening of the throttle, so as to prevent spinning of the wheels, at a desired slowing down of the vehicle. The operability of the motor vehicle is increased.

Advantageous specific embodiments will be described in greater detail below.

It is of advantage if the sensor device is a part of an ESP device. By ESP device one should understand the totality of all devices that are used within the scope of an Electronic Stability Program (ESP). The sensor device ascertains driving dynamics measuring and control variables that permit drawing conclusions concerning roadway conditions. Other parameters, provided by ESP devices and utilized, may also advantageously be used, such as environmental temperature, wheel signals, vehicle deceleration in response to braking, wheel brake pressures, vehicle acceleration, duration and number of ESP interventions, steering angle, yaw speed about the vehicle's vertical axis, vehicle transverse acceleration and perhaps also data of a navigation system. In a computing device these parameters are recalculated into information that characterizes the coefficient of friction of the roadway surface.

The drag torque is implemented using particularly good understanding when the regulating device gives rise to the switching in of a generator or the switching over of an electric motor into the generator operation.

If the regulating device gives rise to a braking intervention, the decelerating element, achieved by the drag torque in motor vehicles driven by internal combustion engines, is particularly well perceivable by the driver, and is simulated in a particularly simple controllable manner.

In order to achieve a gentle response of the drag torque and a possible reduction in the drag torque at too low a coefficient of friction, it is advantageous if the drag torque is reduced slowly as soon as the sensed coefficient of friction is greater than a boundary value.

If the boundary value is preset in a fixed manner, or is adapted to the driving behavior of a driver, then either the same behavior is reproducible for each vehicle or the control behavior is adaptable to the driving dynamics behavior of a special driver.

After a motor vehicle has traveled along a roadway section having a low coefficient of friction, if it then again comes to a roadway section having a high coefficient of friction, it is of advantage if the drag torque is increased again when, as soon as possible after the exceeding of the boundary value, this boundary value is undershot again by the coefficient of friction. After driving along a smooth drivable roadway section, in order, on a traveled, grip-providing roadway section, to be able to go back again to the accustomed decelerating torque, namely the drag torque, this specific embodiment is of particular advantage.

It is of particular advantage, in such a case, if the torque is increased again slowly. Jerk-like changes, sudden changes in torque or the like, are avoided thereby.

The present invention also relates to a device having means suitable for carrying out the method according to the present invention. Such a device provides the advantage that it may be retrofitted and used in motor vehicles already manufactured.

### BRIEF DESCRIPTION OF THE DRAWINGS

In the following text the present invention will be explained in greater detail on the basis of the drawings. The figures show:

FIG. 1 shows a schematic representation of a vehicle driven by an electric motor.

FIG. 2 shows the flow chart in schematic form of the method according to the present invention.

FIG. 3 shows the graph of the drag torque as a function of the setting of the accelerator, the brake pedal and the coefficient of friction on the roadway surface.

### DETAILED DESCRIPTION OF THE INVENTION

FIG. 1 shows a vehicle 1 driven by an electric motor. In the exemplary embodiment shown, a fuel cell automobile is illustrated. Motor vehicle 1 has an electric machine that functions as electric motor 2. Electric motor 2 is able to be switched over to a generator operation. In generator operation, electric motor 2 produces current, just like a generator.

A fuel cell 3 takes fuel from a hydrogen tank 4 and converts this to energy. The energy is supplied to a pulse-controlled inverter 5 and a current transformer 6. Current transformer 6 is designed as a DC/DC converter, in this instance. Current transformer 6 regulates the charging and discharging response of an accumulator 7.

The energy supplied by fuel cell 3 is supplied via pulse-controlled inverter 5 to electric motor 2, which then supplies the energy to wheels 9, while having intermediately connected a clutch and transmission unit 8. Wheels 9 are turned with the aid of electric motor 2, the energy being supplied by the clutch and transmission unit according to requirements.

The force sequence is symbolized in FIG. 1 by arrows.

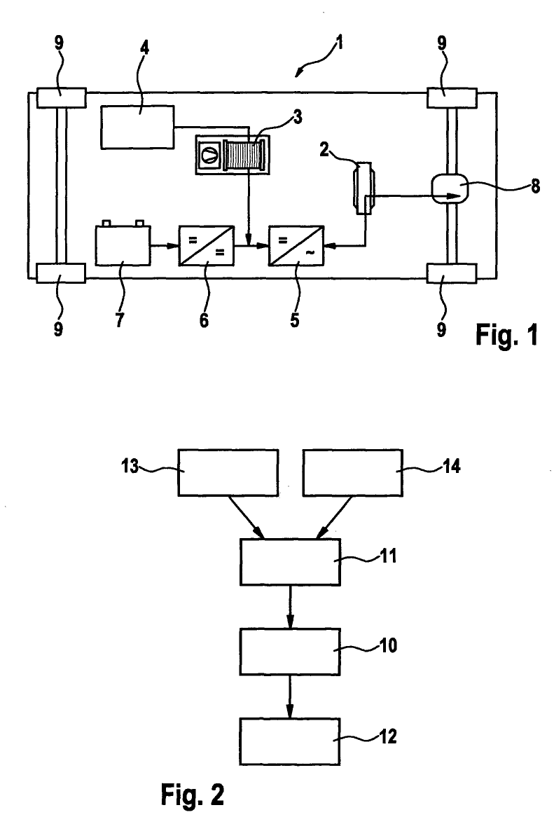

FIG. 2 shows a schematic sequence of the method according to the present invention. A regulating device 10 receives a triggering signal from a computing device 11, so that regulating device 10 triggers measures 12 which lead to a reduction in drag torque. Data are supplied to computing device 11 by a sensor device 13, which represent the coefficient of friction on the roadway surface. An accelerator position determination device 14 supplies additional information and data, with respect to the setting of the accelerator, to computing device 11.

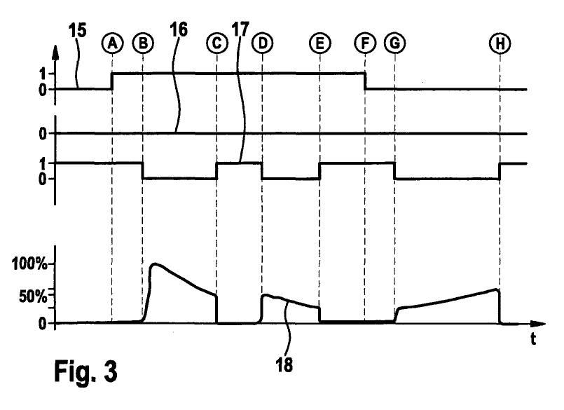

If the accelerator is moved from a position, in which the accelerator is controlling the propulsion, to a neutral position, that is, to a position in which no additional acceleration is effected, in the sense that “gas is reduced”, and if a slippery roadway surface is detected by sensor device 13, regulating device 10 calls for measures that lead to a reduction in the drag torque.

Whereas during normal roadway surface conditions, that is, at sufficiently great coefficient of friction during “taking the foot off the gas” gives rise to an artificial deceleration, that is, an increase in the drag torque, at this point only little drag torque is still artificially added, so as to avoid blocking of wheels 9. The special effect also becomes clear by studying FIG. 3.

FIG. 3 shows the curve of the coefficient of friction on the roadway surface by a graph 15. In this context, the coefficient of friction jumps between the value 0, that is, the value at which a large coefficient of friction is defined as being sufficient, and the value 1, at which the present coefficient of friction is defined as being low.

A graph 16 represents the position of the brake pedal, that is, it shows that, during the entire time curve t, the brake pedal remains unchanged.

While the brake pedal always remains in the same position, the position of the accelerator changes, as is shown by graph 17. The accelerator changes between a position in a pressed setting, that is, in position “1” and a non-pressed position, that is, position “0”.

The curve of the drag torque is shown with the aid of a graph 18.

Up to a moment A, the driver drives the motor vehicle on a roadway that has a “normal” roadway coefficient of friction, that is, a sufficiently highly defined coefficient of friction. At point in time A, an ESP device which includes sensor device 13, supplies data with respect to a reduced coefficient of friction. As of this point in time, one must assume a low coefficient of friction up to point in time F.

At time B, the driver takes his foot off the gas and, in the case in which the device according to the present invention or the method according to the present invention are not in use, has a high artificial, that is, learned drag torque in motor vehicle 1, which leads to the wheels being able to go into a spin. The usual regulation mechanisms, such as increasing the motor speed to reduce the drag torque, should go into effect. The design approach according to the present invention is reached at point in time D.

Whereas at time C acceleration again took place, at time D a method according to the present invention intervenes and lowers the motor drag torque. The drag torque proportion is reduced, a brake proportion being first omitted, to unload the brakes and to prevent wheels 9 from “going into a spin”.

If the drag torque proportion, otherwise given rise to by switching in the brakes, is not sufficiently great to reduce the drag torque, the generator proportion of the drag torque is further reduced by switching off the generator or by not switching over the electric motor into generator operation.

At time E, gas is given, and at time F, the coefficient of friction increases again to a normal value. Now, if necessary, in this case at time G, at which the driver stops supplying gas again, the drag torque is slowly increased again, until the original value is reached.

As may be seen in the curve of graph 15, that is, the representation of the coefficient of friction, a digital differentiation takes place as to at what point the coefficient of friction has to be regarded as having been undershot. In such a case, the graph has the level “1”.

1-9. (canceled)

10. A method for regulating the drag torque of a motor vehicle driven by an electric motor, a regulating device influencing the drag torque when there is a corresponding change in a setting of an accelerator of the vehicle, comprising: sensing a coefficient of friction of a roadway surface on which the motor vehicle is located and setting a computing device using a sensor device, the computing device causing the regulating device to adjust the drag torque as a function of the coefficient of friction.

11. The method as recited in claim 10, wherein the sensor device is a part of an ESP device.

12. The method as recited in claim 10, wherein the regulating device gives rise to switching in of a generator or switching over of an electric motor to generator operation.

13. The method as recited in claim 11, wherein the regulating device gives rise to switching in of a generator or switching over of an electric motor to generator operation.

14. The method as recited in claim 10, wherein the regulating device gives rise to a braking intervention.

15. The method as recited in claim 11, wherein the regulating device gives rise to a braking intervention.

16. The method as recited in claim 12, wherein the regulating device gives rise to a braking intervention.

17. The method as recited in claim 10, wherein the drag torque is slowly reduced when the sensed coefficient of friction is greater than a boundary value.

18. The method as recited in claim 11, wherein the drag torque is slowly reduced when the sensed coefficient of friction is greater than a boundary value.

19. The method as recited in claim 12, wherein the drag torque is slowly reduced when the sensed coefficient of friction is greater than a boundary value.

20. The method as recited in claim 14, wherein the drag torque is slowly reduced when the sensed coefficient of friction is greater than a boundary value.

21. The method as recited in claim 17, wherein the boundary value is preset in a fixed manner or is adapted to the driving behavior of a driver.

22. The method as recited in claim 17, wherein the drag torque is increased again when, after the boundary value is exceeded by the coefficient of friction, the boundary value is undershot again.

23. The method as recited in claim 21, wherein the drag torque is increased again when, after the boundary value is exceeded by the coefficient of friction, the boundary value is undershot again.

24. The method as recited in claim 22, wherein the drag torque is slowly increased again.

25. A device comprising means for carrying out the method as recited in claim 10.
